(19) United States
(12) Patent Application Publication
(10) Pub. No.: US 2024/0120777 A1
(43) Pub. Date: Apr. 11, 2024

(54) MAGNETIC FLUX SHIELDING SYSTEM IN A CHARGING UNIT

(71) Applicant: ELVY.AI LTD, Tel- Aviv (IL)

(72) Inventors: Oded BROSHI, Haifa (IL); Or HAREL, Tel Aviv (IL); Yonatan MANOR, Haifa (IL)

(21) Appl. No.: 18/263,811

(22) PCT Filed: Feb. 1, 2021
(86) PCT No.: PCT/IL2022/050136

§ 371 Date: Aug. 1, 2023

Related U.S. Application Data
(60) Provisional application No. 63/144,490, filed on Feb. 2, 2021.

(51) Int. Cl. H02J 50/70; H01F 27/36; H02J 50/00; H02J 50/10

(52) U.S. Cl. CPC H02J 50/70; H01F 27/363; H02J 50/005; H02J 50/10

(57) ABSTRACT

The technology disclosed herein concerns a mobile communication device (MCD) charging unit adapted with a shield assembly.

### FIELD OF THE INVENTION

The invention generally relates to a directionally adjusted, partially sealed, magnetic and electromagnetically shielded enclosure for a mobile device charger.

### BACKGROUND OF THE INVENTION

Exposure to artificial electromagnetic fields has been steadily increasing with advancements in development of novel communication devices and specifically due to the observed increase in the manufacturing and use of mobile phones. Numerous studies point out to a potential correlation between radiation (electromagnetic, radio, non-ionizing and/or different radiations related to mobile phones) and observed adverse health effects. These effects include effects on sleep cycles, inducement of headaches, anxiety, suicide and depression, nausea, fatigue, loss of libido, as well as more severe effects on brain functions, development of tumors and cancer, and more.

In 2011, radiofrequency electromagnetic fields emitted from mobile phones and chargers were classified as potentially carcinogenic to humans by the World Health Organization (WHO) and the International Agency for Research on Cancer (IARC). Further, though the knowledge to conclusively assess the risk is insufficient, precautionary measures have been recommended by the US Federal Office for Radiation Protection to minimize the risk of such radiation by maintaining the distance of a mobile phone from a user's head as large as possible.

Charging of a mobile phone in a working, living or resting environment, involves conveniently placing the charger and the mobile phone within a reaching distance from the user. While users may have the realization of potential risk, the increased reliance on mobile phones for communication, data, work and management of daily activities mandates positioning of a mobile phone in full accessibility to the user and full functionability even when being charged.

### SUMMARY OF THE INVENTION

The dangers of electromagnetic radiation and magnetic and electromagnetic fields caused by charging of any chargeable device, e.g., mobile communication devices such as mobile phone and smartphones, has led the inventors of the technology disclosed herein to develop a charging unit for a wireless mobile communication device that blocks or significantly lowers level of exposure to radiation, i.e., of both electric and magnetic fields, without limiting the basic functions of the device. The charging unit utilizing a radiation reflecting, deflecting and/or absorbing material, provides a safer wireless charging based on predefined safety parameters, as disclosed herein.

In a first of its aspects, the invention provides a mobile communication device (MCD) charging unit provided with a positionally adjustable magnetic and electromagnetic (partially enclosing) shield assembly, said shield assembly being of a shape and size defining a radiation shadow zone exhibiting low to no MCD-emitted radiation, wherein operation of a device being charged or of the MCD is substantially unaffected by the shield assembly. In some embodiments, the MCD is provided with a device in a state of charging.

In another aspect, there is provided a mobile communication device (MCD) charging unit provided with a positionally adjustable (partially enclosing) magnetic and electromagnetic shield assembly, said shield assembly being of a shape and size selected to provide a substantially radiation free region spanning the radiation shadow zone defined by the shape and size of the shield assembly, wherein operation of a device being charged or of the MCD is substantially unaffected by the shield assembly. In some embodiments, the MCD is provided with a device in a state of charging.

The invention further provides a desktop or a wall mounted MCD charging unit equipped with a partially enclosing magnetic and an electromagnetic shield assembly, the shield assembly being configured and operable to prevent or reduce magnetic field and electromagnetic radiation emitted from the unit (charger and/or the MCD) at a direction of the shield assembly from crossing the assembly, or a plane defined by the shield profile, i.e., size and shape of the shield, wherein operation of a device being charged or of the MCD is substantially unaffected by the shield assembly. In some embodiments, the MCD is provided with a device in a state of charging.

Further provided is a charging unit of a MCD, the charging unit being equipped with a front magnetic and electromagnetic shield assembly forming a partial enclosure provided to prevent or lower magnetic flux or electromagnetic radiation emitted from said unit across the enclosure, wherein operation of a device being charged or of the MCD is substantially unaffected by the shield assembly. In some embodiments, the MCD is provided with a device in a state of charging.

Also provided is a mobile communication device (MCD) charging unit provided with a (positionally adjustable) magnetic field and electromagnetic radiation partially enclosing shield assembly, said shield assembly comprising a conductive material and being of a shape and size selected to provide a substantially radiation free region that spans a radiation shadow zone defined by the shape and size of the shield assembly.

A desktop mobile communication device (MCD) charging unit is also provided. It is equipped with a magnetic and an electromagnetic partially enclosing shield assembly, the shield assembly being or comprising a conductive material and is configured and operable to prevent or reduce magnetic field and electromagnetic radiation emitted from the unit at a direction of the shield assembly from crossing a plane defined by the shield profile.

The device may be a wall mounted mobile communication device (MCD) charging unit which is equipped with a magnetic and an electromagnetic partially enclosing shield assembly, the shield assembly being or comprising a conductive material and is configured and operable to prevent or reduce magnetic field and electromagnetic radiation emitted from the unit at a direction of the shield assembly from crossing a plane defined by the shield profile.

The “charging unit” or “charger” of the invention is an electrically wired or wireless or electromagnetic induction-operated unit, suitable for charging a mobile communication device (MCD) of a variety of sizes and uses. Such MCDs include mobile phone, smartphone, ultramobile PC, mobile internet device, personal navigation device, smart watches, earphones, smart glasses and others. The charging unit is typically a desktop unit, namely a unit that is stationary having a base, or a wall mounted device, that includes features such as a charging station or a charging slot that is configured to receive the MCD for charging, a power bank, a battery or an equivalent power source unit, a power cable unit (typically utilizing a USB port) and/or other features. The shield assembly provided for minimizing or diminishing exposure of a user to radiation emitted from the charging unit and/or the MCD is typically positioned at the front of the unit, oriented in a direction facing the user and parallel to an axis defined by the orientation of the charging station or charging slot that is configured for receiving the MCD for charging. Alternatively or additionally, the shield assembly may be positioned at any side of the unit facing the user.

In some embodiments, the charging unit is provided with a USB port adapted to receive an electrical power cord to attach to a grounded or a non-grounded power source.

The charging station provided in a charging unit of the invention may be of any shape and size permitting uninterrupted positioning of the device to be charged behind the shield assembly and into or onto the charging station; hence providing uninterrupted charging. The charging station may be provided in a variety of forms that are configured for the specific device to be charged. The charging station may comprise or be provided in a form of a slot or a docking element in which the device may be inserted or positioned, as an inductive pad or inductive surface on which the device may be placed, or generally in any other form having a surface charging element.

Where a mobile phone is the device of choice, the charging station may be formed as a docking element (a charging slot) for wire or wireless charging.

The “magnetic and electromagnetic shield assembly” or generally the “shield” is a physical barrier structured of one or a plurality of material strata or layers that are assembled into a unified shield element. At least one stratum is provided of a material responsive to radiation emitted from the device or charger unit, said radiation being electromagnetic radiation and/or magnetic field. The other stratum may be present to provide a robust structural support, may be present for aesthetic purposes or may provide additional functionalities or features to the shield assembly, as discussed below. The strata may be separable or detachable or provided as an inseparable assembly.

The shield assembly may extend from a bottom surface of the unit, i.e., in case of a desktop charger, from the surface on which the unit is positioned, or from a distance close to the bottom surface of the unit, to a minimum height defined by the length of the MCD which charging is desired. In some cases, shield assembly is shaped to comprise the bottom surface of the unit, such that the shield assembly adopts an L-shaped design. In other words, the profile of the shield assembly, e.g., shape and dimensions, are selected to at least correspond to the length and width of the MCD, e.g., mobile phone. To adjust the shield assembly to provide effective shielding to a user facing the device, the shield assembly may be positionally adjustable. In such a configuration, the shield assembly may be provided in an adjustable frame or a rail assembly which allows adjustment of the shield position relative to the charging station or the MCD.

The shield assembly is “a partial enclosure” that is defined by the shield shape. In other words, the MCD of the invention is not fully enclosed or encapsulated within a compartment or a pocket or an enclosure that fully surrounds the unit. The shield provides a directional, front or side protection to a user from radiation (electromagnetic radiation or magnetic field) emitted from the device. Side and back faces of the MCD or device positioned therein may be exposed, namely unshielded.

To provide maximum protection against emitted radiation and/or field, the shield assembly may be positioned at a distance from the charging station or the MCD that provides a maximal radiation shadow, namely the broadest zone at the front region of the shield assembly that is free or substantially free of emitted radiation and/or field (flux). Such a distance may be between few millimeters to a few centimeters, as measured from the charging station. To further maximize the number of mechanisms by which the emitted radiation can be prevented from crossing the shield assembly, or to contain the emitted radiation in close proximity to the charging unit, i.e., within the partial enclosure defined by the shield assembly, the shield assembly is selected to be or comprise a material responsive to electromagnetic radiation or magnetic field (flux); namely a material that absorbs or reflects or retards incident radiation or magnetic flux. Such a material may be a conductive material.

The conductive material used in constructing shield assemblies of the invention may be varied based on the particular design of the charging unit and the desired reduction in radiation emission. For example, in cases where complete shielding cannot be provided by using a particular conductive material, a combination of materials may be used.

In most general terms, the shield assembly may comprise at least one component or element formed of a conductive material selected from metals, conductive carbonaceous materials, conductive ceramics, conductive polymers, and hybrids or composites thereof.

In some embodiments, the shield assembly comprises a conductive material embedded in a matrix material such as a polymeric material. The conductive material may be presented as a continuous material sheet or as a dense population of material particles, such as nano or microparticles embedded in a matrix material.

In some other embodiments, the conductive material may be provided in a sheet form that is sandwiched or layered between polymeric material layers that protect the conductive material and also provide it with the required robustness and stiffness.

In some embodiments, the conductive material is provided as a layer coat on a surface of a shield chassis.

The polymeric material or matrix material providing support of a solid medium for holding the conductive material, as disclosed in embodiments of the invention, may be selected from or may comprise polyethylene (PE), polyethylene terephthalate (PET), polybutylene terephthalate (PBT), polycarbonate (PC), acrylonitrile butadiene styrene (ABS), polyamide (PA or nylon), polypropylene (PP), epoxides, polyether ether (PEEK), polystyrenes, polyaniline (PANI), polyurethane, unsaturated polyester, polyacrylates such as polymethyl methacrylate (PMMA) and others.

In some embodiments, the conductive material is a metallic material provided as a single metallic component, as a conductive metallic composition (comprising two or more metals or one metal and one or more additional non-metal component) or as a conductive alloy. The metallic component may be a metal selected from aluminum, silver, copper, gold, and alloys thereof.

In some embodiments, the metal is provided as a metal sheet within or between sheets of a solid matrix material, e.g., polymeric material.

The one or more of the strata making up the shield assembly or the assembly as a whole may be transparent or opaque and may be provided as a detachable and replicable unit which may be replaced when damaged or per user desires.

In some embodiments, the shield assembly is a multi-layered structure comprising two or more layered components, optionally of the same size and shape, wherein one or more of the components is or comprises a conductive material or generally a material responsive to electromagnetic radiation or magnetic fields, thus providing electromagnetic shielding and shielding from magnetic fields.

In some embodiments, the shield assembly is in a form of a single metal sheet. The shield assembly is structurally and compositionally configured to fully or partially prevent radiation emission from the charging unit or MCD, e.g., mobile phone, from crossing the shield assembly by absorbing, deflecting, or reflecting radiation. Depending on the MCD, e.g., mobile device used, the radiation may be an electromagnetic radiation, including microwave or radio radiation and non-ionizing radiation or a magnetic field.

The size and shape of the shield assembly is said to provide “a substantially radiation free region that spans the radiation shadow zone”. As depicted in FIG. 5, the radiation shadow zone is a region protected from direct emitted radiation due to the height, width and/or shape of the shield. In other words, the shadow zone is substantially free of radiation emitted from the unit. Depending on the shield material or composition used, the shield is configured to absorb, deflect, or in some cases reflect at least 80% of the emitted radiation or field. In other words, within the shadow zone, the intensity of the radiation is at most 20% of the radiation measured at a given location at the front of the shield relative to the amount of radiation measured at the same location for a device absent a shield. In some embodiments, the shield assembly provides a reduction of at least 80, 85, 90, 91, 92, 93, 94, 95, 96, 97, 98, 99 or 100% of the emitted radiation measured as above, and thus shielding reduces radiation within the shadow zone to between 20 and 0%.

Thus, MCDs of the invention, provided with a shield assembly as disclosed, e.g., comprising a conductive layer such as a metallic layer, reduces at least 80% of the radiation measured at a given location at the front of the shield (within the shadow zone) relative to the amount of radiation or field measured at the same location for a device absent a shield of the invention. In some embodiments, the reduction is between 80 and 100% or between 90 and 100%, or between 90 and 99% or between 90 and 98, 97, 96, 95, 94, 93 or 92%.

In some embodiments, the shield assembly comprises or consists a metallic sheet absorbing or deflecting at least between 90 and 100% of the radiation emitted by the device when measured at a given location at the front of the shield relative to the amount of radiation measured at the same location for a device absent a shield.

In some embodiments, the shield assembly absorbs or deflects up to 85, 90, 95, 96, 97, 98 or 99% of the radiation.

Unlike known enclosures for minimizing user exposure to radiation emitted from the charging unit or mobile phone associated therewith, the charging unit is not fully enclosed within shield walls. The shield assembly of the invention is unidirectional, namely it provides shielding from radiation and field emitted only at a direction facing the user and independent on the orientation of the MCD within the unit. In some configurations, the shield assembly provides shielding from radiation emitted at a direction that is substantially perpendicular to the front face of the MCD being charged, as detailed in FIG. 5. Radiation emitted backwards or sideways from the MCD or unit is not blocked. Any of these configurations not only permit efficient and effective protection from emitted radiation, but also enable uninterrupted functionality of the MCD, e.g., mobile phone, i.e., incoming and outgoing communication, data exchange, panel operation, etc.

The shield assembly may be provided with a front panel or a display panel optionally comprising a touch element and a user interface. The front panel may be in a form of a liquid crystal display (LCD), an in-plane switching liquid crystal display (IPS-LCD), a smart glass, an organic light-emitting diode (OLED) or an active-matrix organic light-emitting diode (AMOLED). The display may be used to present or exhibit any desired information, including time, date, temperature, level of radiation, textual displays of messages, news, etc.

The MCD unit and display panel may also be configured as an IOT device having the means and capability of connecting to and exchanging data with other devices and systems over the internet or other communications networks.

The shield assembly may have a front made of a switchable glass (smart glass) with light transmission properties that can be modified upon application of light, voltage or heat. In such configurations, the shield external surface may be constructed by lamination with a switchable film, using glass, acrylic or polycarbonate laminates.

A unique configuration of a front panel of a shield assembly provides screen mirroring, replicating a phone, laptop, tablet or computer screen onto the panel display. This can be achievable by a wired connection or by wireless connection. The screen mirroring may also be used to replicate to the front panel of the shield any incoming information received by the MCD, while placed in the charger, such as messages, emails, news updates, etc. Adapted with a touch element, screen sharing may also provide safe means for using the MCD, while being charged.

The invention further provides a mobile phone charging unit provided with a positionally adjustable magnetic field and electromagnetic radiation partially enclosing shield assembly, said shield assembly comprising a conductive material and being of a shape and size selected to provide a substantially radiation free region that spans a radiation shadow zone defined by the shape and size of the shield assembly.

Also provided is a desktop mobile charging unit equipped with a front magnetic and an electromagnetic shield assembly, the shield assembly being or comprising a metallic material and is configured and operable to prevent or reduce between 80 and 100% of the magnetic field and electromagnetic radiation emitted from the unit at a direction of the shield assembly from crossing a plane defined by the shield profile, when measured at a given location at the front of the shield relative to the amount of field and radiation measured at the same location for a device absent a shield.

In some embodiments, the shield assembly reduces between 90 and 100% of the field and radiation.

In some embodiments, the conductive material is aluminum.

In some embodiments, the unit is a wall mounted device.

In some embodiments, the shield assembly is provided at the front of the unit, oriented in a direction facing the user and parallel to an axis defining the orientation of a charging station configured for receiving the device for charging.

In some embodiments, the shield assembly is inclined in a direction of a charging station.

The invention further provides a kit comprising a charging unit for a mobile communication device and a shield assembly configured and operable for mounting on said unit; and instructions of use.

In some embodiments, the kit is for assembling a unit according to the invention.

Also provided is a method for reducing electromagnetic radiation and/or magnetic field emitted from a mobile device, the method comprising mounting to a charging unit of a mobile communication device, at a direction facing a user, a shield assembly comprising a conductive material and being of a shape and size selected to provide a substantially radiation free region that spans a radiation shadow zone defined by the shape and size of the shield assembly.

All embodiments relating to a unit or a device or a kit of the invention are equally applicable to a method of the invention.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIG. 1 schematically depicts multidirectional emission of radiation from a conventional mobile communication device such as a mobile phone.

FIG. 2 schematically depicts the effect of a shield assembly of the invention on the multidirectional emission of radiation from a communication device.

FIGS. 3A-C illustrate charging units according to some embodiments of the invention. FIG. 3A depicts a unit with a curved shield. FIG. 3B depicts a unit with a flat shield and FIG. 3C depicts a unit with shield aligned perpendicularly to the base of the unit.

FIG. 4 illustrates a charging unit according to another embodiment of the invention.

FIG. 5 illustrates a radiation shadow.

FIG. 6 provides a schematic depiction of the measurement setup.

FIG. 7 provides a schematic top view of the measurement setup.

FIGS. 8A-D provide a schematic depiction of measured results, electromagnetic radiation and magnetic field recorded values. FIG. 8A depicts test results of magnetic field under test Conditions A; FIG. 8B depicts test results of electromagnetic radiation under test conditions A; FIG. 8C depicts test results of magnetic field under test Conditions B; FIG. 8D depicts test results of electromagnetic radiation under test Conditions B.

### DESCRIPTION OF EMBODIMENTS OF THE INVENTION

Reference will now be made to non-limiting examples of charging units according to the invention.

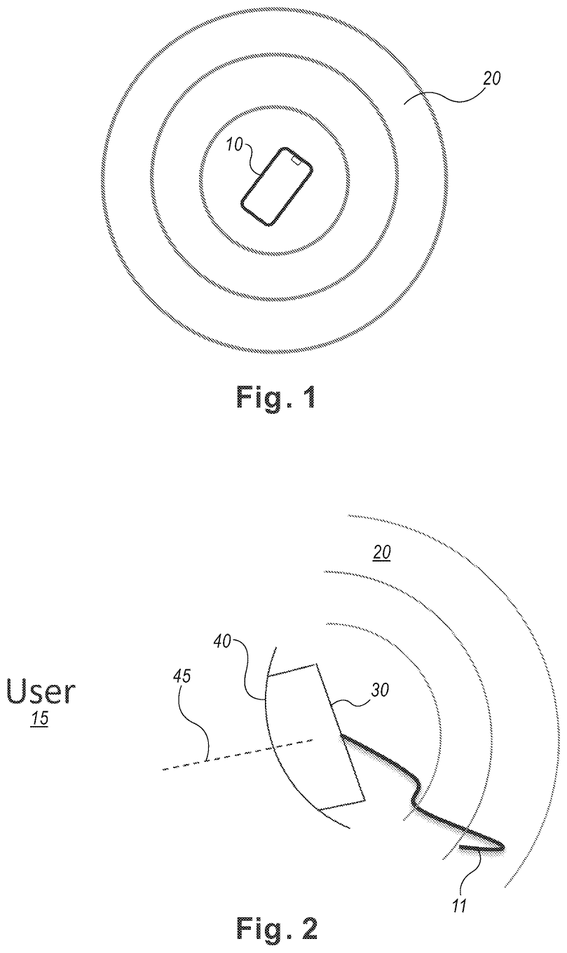

As known in the art, to communicate wirelessly a mobile communication device (MCD), such as a mobile phone, must communicate with a base station that is typically positioned at some distance therefrom. Since antennas on such devices are not directive, the high-frequency electromagnetic radiation emitted from the phone is transmitted in all directions, as shown in FIG. 1 for a mobile phone 10. To limit exposure of a human or animal subject in the vicinity of the MCD to emitted radiation 20, particularly where the phone is charging, the inventors of the technology have devised a charging unit that reduces radiation emission in a preselected region of the MCD. As shown in FIG. 2, a charging unit 30 according to some embodiments of the invention is provided with a shield assembly 40 configured to minimize multidirectional emission of radiation 20 in a direction of a subject or user 15, such that radiation is reflected backwards, absorbed or prevented from crossing a plane (which may be a flat two-dimensional surface or a curved surface) defined by the physical barrier being the shield assembly 40. In some configurations, and as shown in the figure, the shield assembly may be positioned substantially perpendicular 45 to the plane of the MCD, e.g., mobile phone. It should be noted that the shield assembly 40 may be positioned in a direction facing the user and independently of the orientation of the MCD in the charger unit. In other words, in some embodiments, the assembly is substantially parallel to the front face of the mobile phone, while in others, the assembly may be positioned at any angle to the front face of the mobile phone.

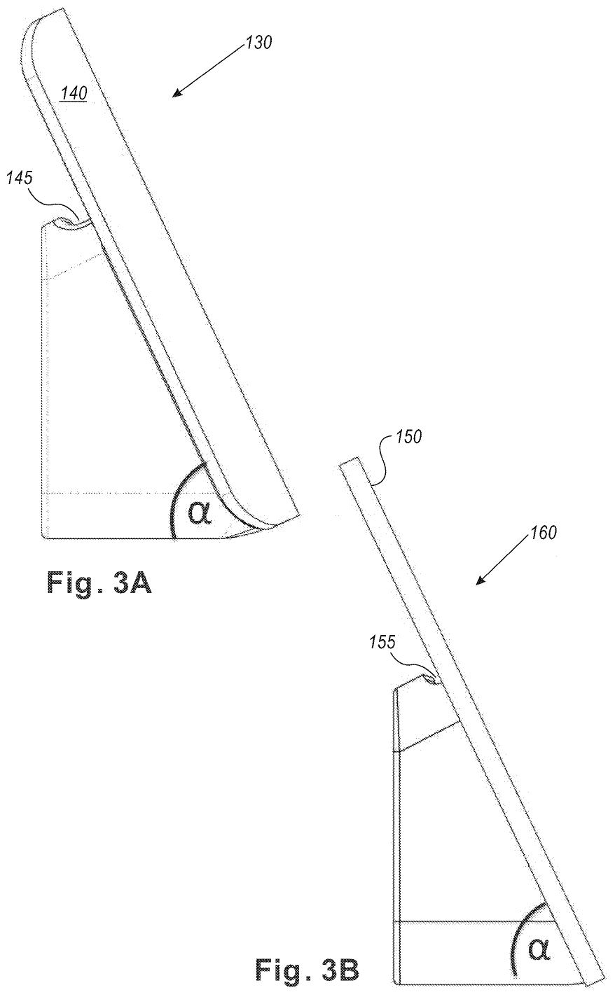

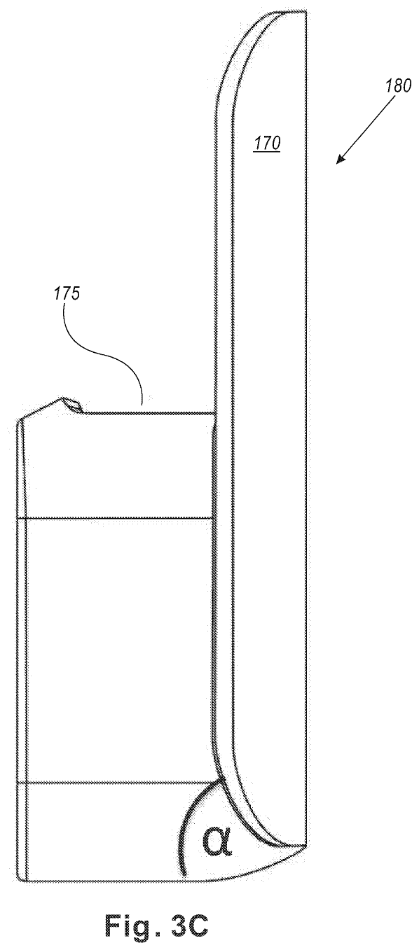

As further shown in FIG. 2, a charging unit 30 is provided with a shield assembly 40 that is curved inwards in a direction of the unit. A side view of such a unit is shown in FIG. 3A, wherein unit 130 has a curved and inwards inclining or leaning shield assembly 140 and a charging station shaped as a charging slot 145. Alternatively, as shown in FIG. 3B for a unit 160, shield 150 may have a planar profile.

The shield assembly 40, 140 and 150 shown in FIGS. 2 and 3A-B, respectively, may be inclined or may be positioned at any angle α (shown in FIGS. 3A and 3B) with respect to the base of the unit. The inclining angle α with respect to the base of the unit may by any angle. For some units, the angle α may range from 40° to 90°. FIG. 3C shows such a unit 180 wherein the shield assembly 170 is substantially perpendicular to the base plane of the unit.

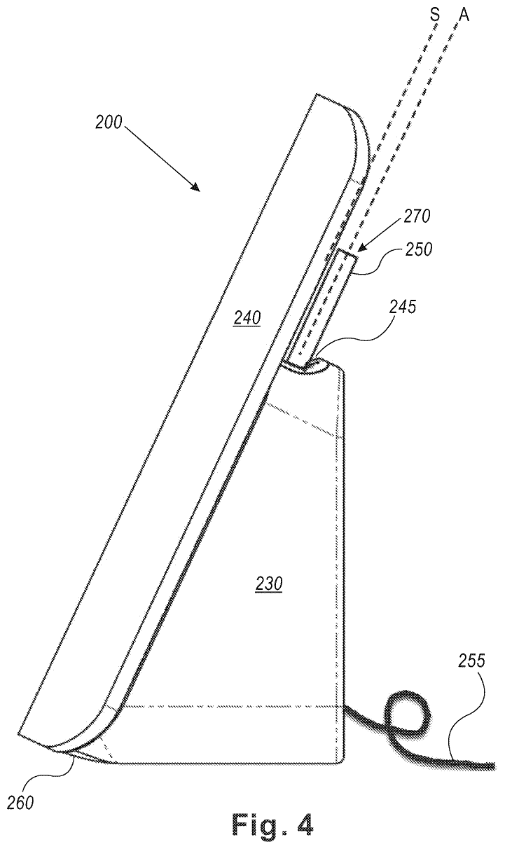

FIG. 4 shows another exemplary charging unit 230 with a mobile phone 250 positioned in a charging station e.g., a charging slot 245 and having an electrical power cord 255 extending from the base 260 of the charging unit. The power cord may be similarly provided in any other part of the charging unit.

The shield assembly 240 is inclined inwards in a direction of the charging unit and is substantially parallel to axis A defining the longest axis of the mobile phone (or an axis defined by the orientation of the charging station or charging slot that is configured for receiving the MCD). The unit may be considered in some configurations a shielded enclosure unit, whereby the dimensions of the shield 240 may be selected to extend the length and width of the mobile phone 250. The width and concavity of the shield 240 may also be varied to provide broader or more limited shielding from radiation emitted from the unit (mobile phone and/or charger).

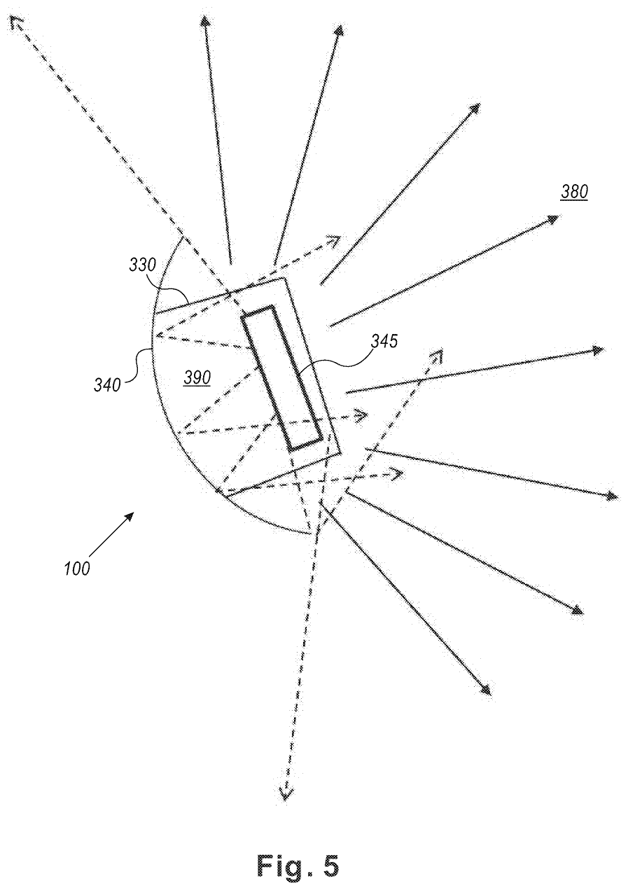

As further shown in FIG. 4 for a unit 200, the shield assembly 240 substantially extends from a bottom surface 260 to a minimum distance defined by the length of the MCD. In the embodiment of FIG. 4 the shield assembly 240 extends higher than the top 270 of the mobile phone 250. To provide maximum protection against emitted radiation, the shield assembly is positioned at a distance defined by the distance between the axis A defining the long axis of the mobile phone or the charging slot and axis S defining the center of the shield assembly, both axes running substantially parallel to each other. Such a distance may be between few millimeters to a few centimeters. The distance is selected to provide a maximum radiation shadow 100, as shown in FIG. 5.

FIG. 5 provides a depiction of a charging unit 330 having a charging station, e.g., a charging slot 345 and a concave shield assembly 340. Radiation emitted from a mobile phone positioned in the slot 345 is omnidirectional, distributed to all directions (indicated by the plurality of arrows 380). Radiation 390 incident to the shield assembly 340 is either absorbed by the assembly, at times reflected or generally prevented from crossing the shield, leaving zone 100 at the front region of the shield assembly 340 substantially radiation free. This region or zone is regarded “a radiation shadow”.

To further maximize the number of mechanisms by which the emitted radiation and/or field can be prevented from crossing a shield assembly in any configuration of the invention, e.g., 340, or to contain the emitted radiation in close proximity to the charging unit 330, i.e., within the partial enclosure defined by the shield assembly 340, the shield assembly 340 is selected to be or comprise a material responsive to electromagnetic radiation; namely a material that absorbs or reflects or retards incident radiation. Such a material may be a conductive material.

### Attenuation Tests

### Background

A set of radiation attenuation measurements were performed on a device of the invention—a 15 W induction based mobile phone charger.

The measurements were conducted as follow:
Testing a Samsung “S20” device.
Testing in four different working modes.
Measuring in eight sectors, 45 degrees apart, where 0 represents the center of the charging phone screen.
The measurements recorded the peak noted value, scanning along the sector middle line and throughout the mobile phone height, top to bottom.
The measurements were conducted with and without the radiation shield.

### Tests

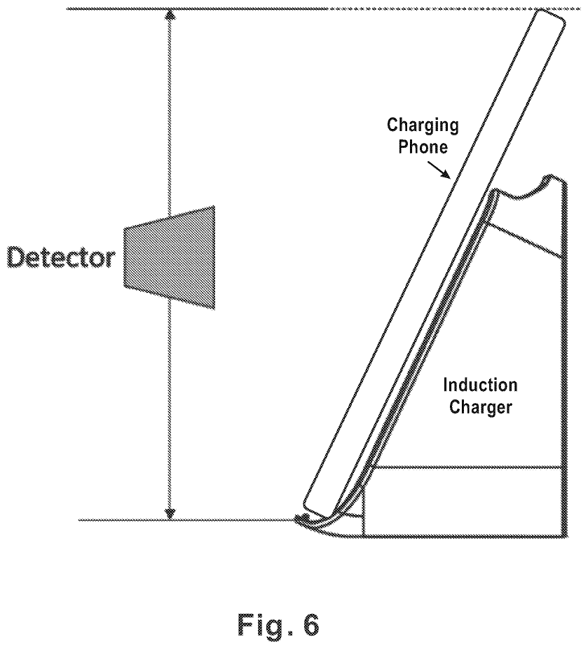

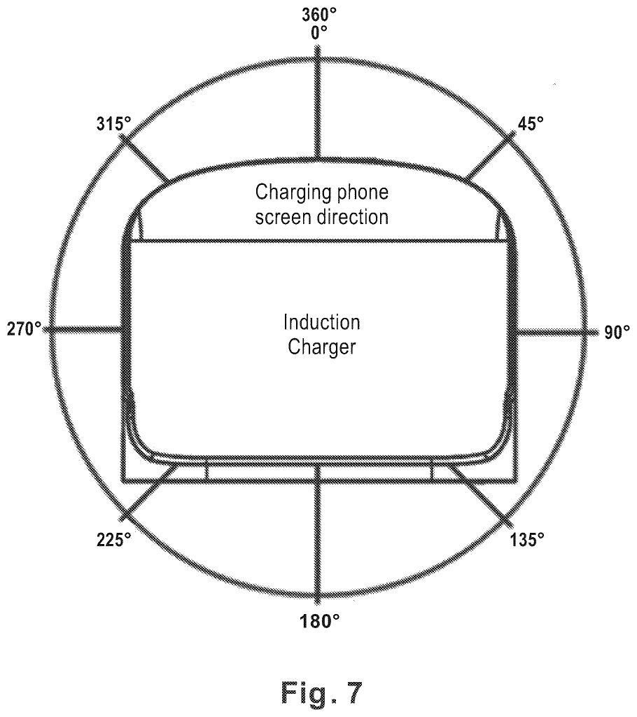

The measurements were conducted along 8 sectors, 45 degrees apart, where 0 degrees represent the center of the charging phone screen, equivalent to the center of the shield when assembled. The measurements recorded the peak noted value, at 1 cm distance from the surface, while scanning along the sector line and throughout the mobile phone height, top to bottom (FIGS. 6 and 7).

The measurements included different function modes of operations, whereas the basic mode included active charging and Bluetooth communication with a nearby laptop in a hotspot mode, while a You-tube stream was active (Table 1). The tests were repeated twice per function mode, measuring electric radiation and magnetic field separately, with and without the assembled shield.

TABLE 1
Functionality modes while testing.

| | | Reception | Ongoing | | |
|---|---|---|---|---|---|
| | Charging | level* | voice call | Hot-Spot** | Bluetooth*** |
| A | x | High | | x | x |
| B | x | Low | x | x | x |

*High = 4 bars (max), Low = 1 bar or less
**Youtube movie running on a nearby laptop
***Active connection

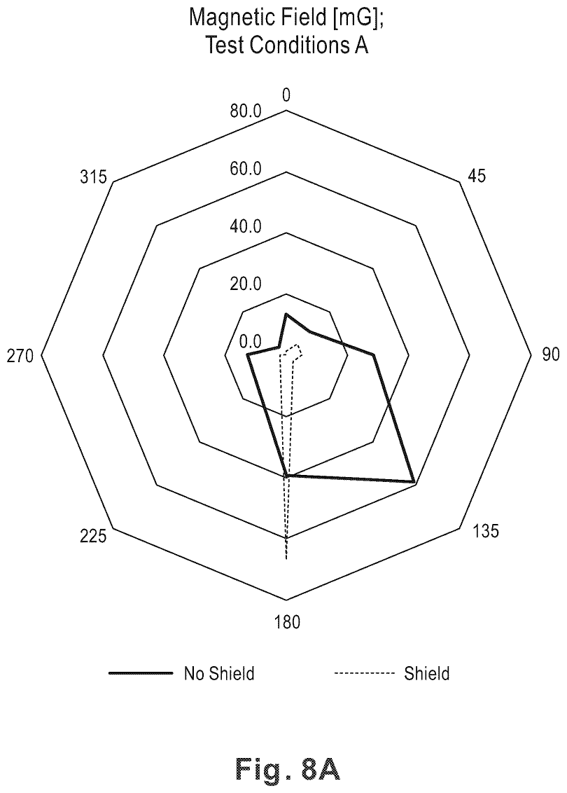

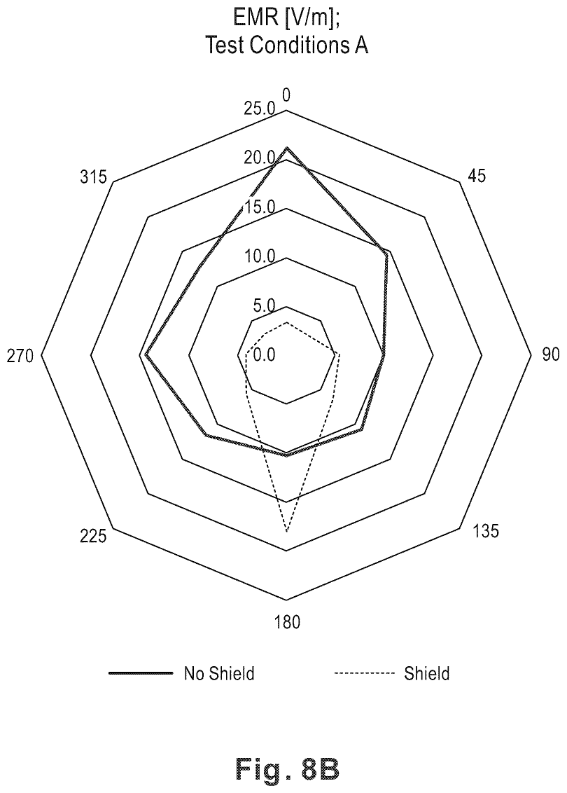

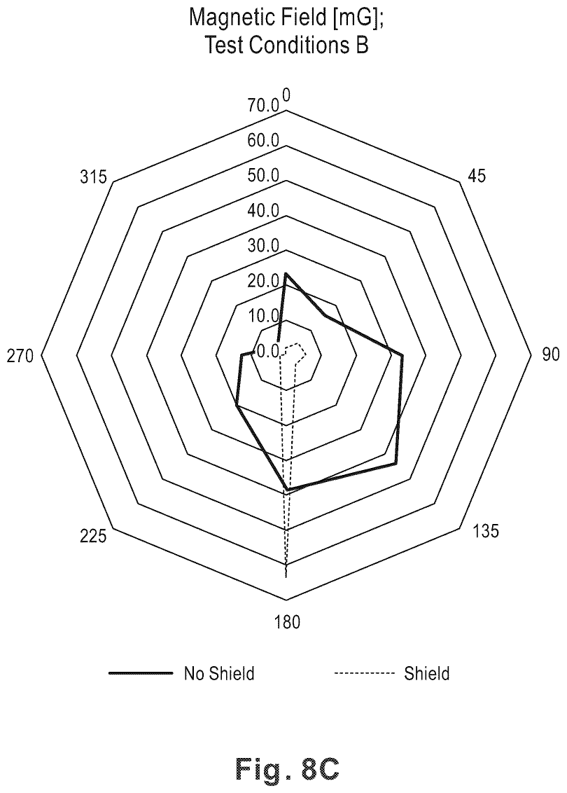

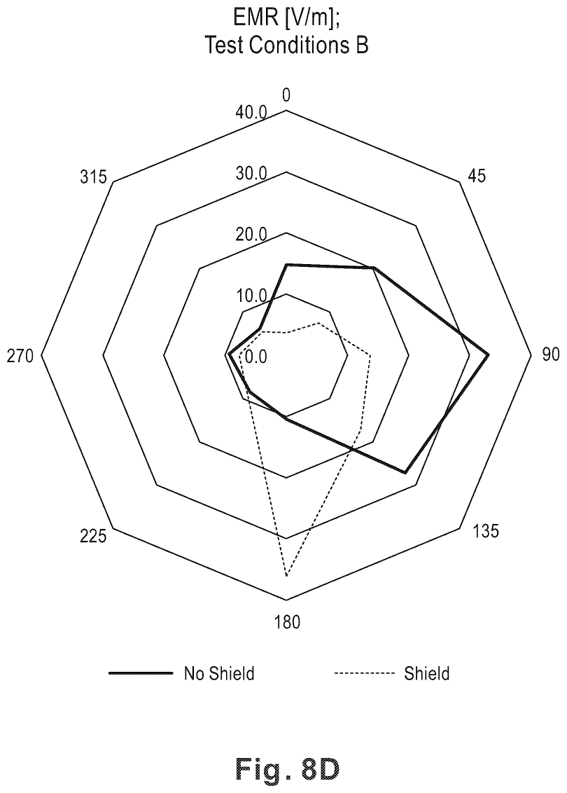

The test mobile phone used was a Samsung Galaxy S20. Reception levels were controlled by conducting the test in a shielded room and by adjusting the access door gap, from fully open to slightly open only. The measured results, electromagnetic radiation and magnetic field recorded values are summarized in Table 2. The results for Test Conditions A and B as defined in Table 1 are further schematically depicted in FIGS. 8A-D.

TABLE 2
Measured results, EMR and magnetic field recorded

| | Test conditions- A | | | | Test conditions- B | | | |
|---|---|---|---|---|---|---|---|---|
| | Unshielded | | Shielded | | Unshielded | | Shielded | |
| | EMR | | Magnetic Field | | EMR | | Magnetic Field | |
| | (V/m) | | (mG) | | (V/m) | | (mG) | |
| | Without | With | Without | With | Without | With | Without | With |
| | shield | shield | shield | shield | shield | shield | shield | shield |
| | of the | of the | of the | of the | of the | of the | of the | of the |
| Orientation | invention | invention | invention | invention | invention | invention | invention | invention |
| 0 | 21.1 | 3.3 | 13.4 | 1.2 | 14.8 | 3.7 | 23.4 | 2.2 |
| 45 | 14.4 | 2.8 | 10.7 | 5.1 | 20.1 | 7.4 | 15.9 | 5.0 |
| 90 | 9.9 | 5.4 | 28.7 | 5.2 | 33.0 | 13.7 | 33.4 | 5.6 |
| 135 | 10.8 | 6.6 | 59.2 | 3.0 | 27.3 | 17.2 | 44.2 | 3.9 |
| 180 | 10.3 | 18.2 | 39.7 | 67.0 | 10.4 | 36.2 | 38.6 | 63.7 |
| 225 | 11.7 | 5.8 | 14.2 | 2.8 | 8.5 | 9.1 | 20.1 | 2.2 |
| 270 | 14.4 | 4.2 | 12.9 | 2.3 | 9.3 | 7.7 | 12.6 | 1.7 |
| 315 | 12.6 | 3.1 | 3.5 | 0.3 | 6.2 | 5.5 | 3.3 | 0.4 |

### CONCLUSION

As demonstrated, a shield assembly in a unit of the invention reduces up to 95% of the emitted field. This means that substantially all of the radiation emitted by the MCD unit is contained, reflected or generally arrested from crossing the shield assembly. The invention unit was determined to comply with the Israeli environment standards requirements for continuous use.

1-43. (canceled)

44. A device comprising:
a. a mobile communication device (MCD) charging unit provided with a positionally adjustable magnetic field and electromagnetic radiation partially enclosing shield assembly, said shield assembly comprising a conductive material and being of a shape and size selected to provide a substantially radiation free region that spans a radiation shadow zone defined by the shape and size of the shield assembly, wherein the shield assembly is structured of one or a plurality of material strata assembled into a unified shield element; or
b. a desktop mobile communication device (MCD) charging unit equipped with a magnetic and an electromagnetic partially enclosing shield assembly, the shield assembly being or comprising a conductive material and is configured and operable to prevent or reduce magnetic field and electromagnetic radiation emitted from the unit at a direction of the shield assembly from crossing a plane defined by the shield profile, wherein the shield assembly is structured of one or a plurality of material strata assembled into a unified shield element; or
c. a wall mounted mobile communication device (MCD) charging unit equipped with a magnetic and an electromagnetic partially enclosing shield assembly, the shield assembly being or comprising a conductive material and is configured and operable to prevent or reduce magnetic field and electromagnetic radiation emitted from the unit at a direction of the shield assembly from crossing a plane defined by the shield profile, wherein the shield assembly is structured of one or a plurality of material strata assembled into a unified shield element.

45. The device according to claim 44, being an electrically wired, wireless or electromagnetic induction-operated unit.

46. The device according to claim 44, wherein the MCD is selected from a mobile phone, a smartphone, an ultramobile PC, a mobile internet device, a personal navigation device, a smart watch, smart glasses, and earphones.

47. The device according to claim 44, wherein the shield assembly extends from a bottom surface of the charger unit to a minimum distance defined by the length of the MCD, or wherein the shield assembly is positioned at a distance from a charging station selected to provide a maximum radiation shadow.

48. The device according to claim 44, wherein the material strata comprise one or more stratum selected to provide a robust structural support, aesthetic purposes or at least one functionality to the shield assembly.

49. The device according to claim 44, wherein the strata is structured of a plurality of separable or detachable strata.

50. The device according to claim 44, wherein the material strata comprise a material responsive to electromagnetic radiation or magnetic field.

51. The device according to claim 50, wherein the material responsive to electromagnetic radiation is a radiation absorbing or reflecting material.

52. The device according to claim 50, wherein radiation emitted from the MCD or the charging unit is absorbed in or reflected from or retarded from the material responsive to electromagnetic radiation.

53. The device according to claim 50, wherein the material responsive to electromagnetic radiation is a conductive material.

54. The device according to claim 53, wherein the conductive material is selected from metals, conductive carbonaceous materials, conductive ceramics, conductive polymers, and hybrids or composites thereof.

55. The device according to claim 53, wherein the shield assembly comprises a conductive material embedded in a matrix material.

56. The device according to claim 44, wherein the shield assembly comprises or consists a metallic sheet absorbing or deflecting at least between 90 and 100% of the radiation emitted by the device when measured at a given location at a front of the shield relative to the amount of radiation measured at the same location for a device absent a shield.

57. The device according to claim 44, wherein the shield assembly is provided with a front panel or a display panel optionally comprising a touch element and a user interface.

58. The device according to claim 57, wherein the front panel is in a form of a Liquid Crystal Display (LCD), smart glass, an In-Plane Switching Liquid Crystal Display (IPS-LCD), an Organic Light-Emitting Diode (OLED), switchable glass, or an Active-Matrix Organic Light-Emitting Diode (AMOLED).

59. The device according to claim 57, wherein the display panel is configured to display information selected from time, date, temperature, level of radiation, textual displays of messages, and news.

60. The device according to claim 44, configured as an IOT device capable of connecting to and exchanging data with other devices and systems over the internet or other communications networks.

61. The device according to claim 44, wherein the front panel of the shield assembly provides screen mirroring, replicating a phone, laptop, tablet, watch or computer screen onto the panel display.

62. A desktop mobile charging unit equipped with a front magnetic and electromagnetic shield assembly, the shield assembly being or comprising a metallic material and is configured and operable to prevent or reduce between 80 and 100% of the magnetic field and electromagnetic radiation emitted from the unit at a direction of the shield assembly from crossing a plane defined by the shield profile, when measured at a given location at the front of the shield relative to the amount of field and radiation measured at the same location for a device absent a shield, wherein the shield assembly reduces between 90 and 100% of the field and radiation.

63. A method for reducing electromagnetic radiation and magnetic field emitted from a mobile device, the method comprising mounting to a charging unit of a mobile communication device, at a direction facing a user, a shield assembly comprising a conductive material and being of a shape and size selected to provide a substantially radiation free region that spans a radiation shadow zone defined by the shape and size of the shield assembly.
